(19) United States
(12) Patent Application Publication
(10) Pub. No.: US 2025/0010556 A1
(43) Pub. Date: Jan. 9, 2025

(54) FIBER-REINFORCED PLASTIC COMPOSITE HAVING IMPROVED UV AND GLOSS PROPERTIES, A PRODUCTION METHOD THEREOF AND USE THEREOF

(71) Applicant: LAMILUX COMPOSITES GMBH, Rehau (DE)

(72) Inventors: Anneli MERKEL, Hof (DE); Dirk FICKENSCHER, Schoenwald (DE)

(21) Appl. No.: 18/712,664

(22) PCT Filed: Nov. 24, 2022
(86) PCT No.: PCT/EP2022/083163

§ 371 Date: May 22, 2024

(30) Foreign Application Priority Data
Nov. 24, 2021 (DE) 10 2021 130 810.0

(51) Int. Cl. B29C 70/30; B29C 70/88; B29K 67/00; B29K 75/00; B29K 105/12; B29K 309/08; B29L 31/00; B29L 31/30

(52) U.S. Cl. CPC B29C 70/30; B29C 70/88; B29K 2067/00; B29K 2075/00; B29K 2105/12; B29K 2309/08; B29K 2995/0055; B29L 2031/3005; B29L 2031/776

(57) ABSTRACT

Disclosed is a fiber-reinforced plastic composite having an improved UV property, to a production method thereof and to the use thereof.

The present invention relates to a fiber-reinforced, multilayer plastic composite, a production process thereof and use thereof.

Fiber-reinforced plastic panels are panels which are composed of composite material. This composite material can be formed, for example, by means of a reinforced polymer resin matrix in which fibers are embedded. Because of the fibers, which provide reinforcement of the polymer matrix, fiber-reinforced plastic products generally have higher specific stiffness and also higher mechanical strength compared to non-reinforced polymer materials.

Advantageously, the term “plate” is understood to be a planar, level structure of the reinforced polymer matrix.

In outdoor use in particular, fiber-reinforced panels often prove to be disadvantageous, as they are exposed without protection to environmental influences, particularly UV radiation and various weather conditions. As a result of these environmental influences, the reinforced polymer matrix is gradually degraded and/or destroyed. In turn, both the esthetic appearance and the mechanical properties of the fiber-reinforced panels suffer as a result and deteriorate significantly over time and due to increasing environmental influences. In the worst case, the environmental influences make the fiber-reinforced product completely unusable. For example, increased brittleness, significant loss of gloss and/or pronounced yellow discoloration of the polymer matrix are to be attributed to environmental influences, UV exposure, and the accompanying aging process of the fiber-reinforced plastic panels.

### Object

The object of the present invention is to provide a plastic composite that has higher gloss stability than the fiber-reinforced plastic products known from the prior art.

Furthermore, it is the object of the present invention to provide a plastic composite which is configured to be virtually free of yellowing, that is to say hardly shows any yellowing even after long periods of use under environmental influences, more advantageously with no yellowing being visible to an observer.

Furthermore, it is the object of the present invention to provide a plastic composite which meets high quality requirements and/or in which defects are reduced.

Furthermore, it is the object of the present invention to provide a plastic composite which has a lower weight than known fiber-reinforced plastic panels.

Furthermore, it is the object of the present invention to provide an optimized plastic composite which shows consistent mechanical properties during aging.

Furthermore, it is the object of the present invention to provide a plastic composite with improved erosion resistance compared to known fiber-reinforced plastic panels.

### Solution

These objects are achieved by means of a fiber-reinforced, multilayer plastic composite as claimed in claim 1.

The essence of the invention lies in providing a fiber-reinforced, multilayer, flat plastic composite with improved UV resistance comprising at least one matrix layer for forming a supporting matrix body and furthermore at least one top layer arranged on the matrix layer, which is configured as a surface seal of the matrix layer and/or as a UV protection layer of the matrix layer, wherein the matrix layer comprises at least one resin from the group of unsaturated polyester resins, vinyl ester resins, epoxy resins, polyurethane resins and/or combinations thereof and the top layer comprises at least one acrylate-based resin, wherein the top layer is configured to undergo deep curing under UV irradiation and wherein at least the matrix layer has a fiber-reinforced configuration, wherein the top layer has a layer thickness in the cured state in the range of 40 to 150 μm, wherein in a 1000-hour test method according to DIN-EN-ISO 4892-2-A1, in the color measurement space L/a/b, the plastic composite has a value delta E of <1.0, and in a 3000-hour test method according to DIN-EN-ISO 4892-2-A1, in the color measurement space L/a/b, it has a value delta E of <1.7.

It has surprisingly been shown that such a plastic composite provides numerous improvements compared to the prior art.

Thus the top layer, which has at least one unsaturated, acrylate-based aliphatic resin, protects the matrix layer arranged underneath from UV damage and the effects of the weather. In addition, such a resin is advantageous because it can be crosslinked in a short time by UV irradiation. In this way, irregularities in the top layer are prevented.

Furthermore, it has surprisingly been found that the top layer comprising the acrylate-based material composition described herein can have a significantly reduced thickness while still correspondingly protecting the underlying matrix material.

Furthermore, with the plastic composite described herein, a significantly reduced total weight is obtained compared to known fiber-reinforced panels of the prior art. A reduction in weight of up to 100 g can thus be advantageously achieved with the plastic composite described herein based on an area of 1 m². Consequently, the plastic composite described herein is particularly suitable for advantageous use in lightweight construction, in the construction sector for building façades, in transport for truck bodies, or in recreational vehicles in the camping sector.

Advantageously, an aliphatic resin is understood to be a resin lacking an aromatic basic structure. This is advantageous because this resin can be crosslinked by UV irradiation without destroying the basic structure in the process. In particular, it has surprisingly been found that this works particularly well with an unsaturated acrylate-based aliphatic resin.

Advantageously, “acrylate-based resin” can be understood to be any type of acrylic resins and/or acrylate resins.

It has been shown to be advantageous for the top layer in the finished end product to have particularly high color stability and particularly high gloss stability. For the entire plastic composite, this means that as a fiber-reinforced plastic composite, it has significantly improved UV resistance and weather resistance, particularly on the visible side. Advantageously, the material of the matrix layer selected from the group of unsaturated polyester resins, vinyl ester resins, epoxy resins, polyurethane resins and/or combinations thereof is to be understood as the base layer material of the matrix layer.

The matrix material is selected in such a way that sufficient flexibility in the cured state is advantageously achieved. Here, resins have been found to be effective which show an elongation at break in the range of 1.0-3.0% (DIN EN ISO 527-4/2/2), more advantageously 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9% or 3.0%. The intermediate values are also disclosed. The elongations at break disclosed here have been found to be advantageous in that they provide material that is particularly easy to process. Lower elongations at break increase the risk of damage due to crack formation. A higher elongation at break results in an overall material with less stiffness, which is clearly found to be detrimental to processing of the resulting plastic composite. The composite ordinarily undergoes subsequent processing into sandwich elements by means of various pressing processes. A less stiff material would tend to show through the inner sandwich construction, which usually causes the surface to be uneven and dented.

In addition to the elongation at break of the resin, the thermal deformation resistance provided is also important. If this parameter is selected too low, thermal deformation may occur in the plastic composite in use of dark materials, which involve a higher thermal load. For this reason, resins have been found to be particularly suitable that show a thermal deformation resistance according to ISO 75 method A of at least 60° C. Resins have been found to be particularly suitable which show a thermal deformation resistance according to ISO 75 method A of between 70-90° C., more advantageously 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C. or 90° C. All intermediate values are also disclosed. It is precisely these values for thermal deformation resistance, determined according to ISO 75 method A, which are advantageous for forming plastic composites that are particularly easy to process and dimensionally stable. Particularly advantageously, the matrix material is selected from the group of polyester resins, vinyl ester resins, epoxy resins, polyurethane resins and/or combinations thereof.

For the first time, the present invention provides a total system as a plastic composite of fiber-reinforced plastic, allowing selection of virtually any color desired, and having maximum UV stability, which considerably minimizes or completely prevents yellowing, even over a period of years.

The UV resistance of the top layer and/or the plastic composite and/or the matrix layer can be evaluated based on the properties of color change in the color measurement space L/a/b with the value delta E and/or based on loss of gloss.

Furthermore, it has been found to be advantageous that in a 1000-hour Xeno-test, a test method according to DIN EN ISO 4892-2-A1, also known as the Accelerated Weathering Test according to DIN EN ISO 4892-2-A1, in the color measurement space L/a/b, the plastic composite described herein has a value delta E of <1.0, and in a 3000-hour Xeno-test, a test method according to DIN EN ISO 4892-2-A1, also known as the Accelerated Weathering Test according to DIN EN ISO 4892-2-A1, in the color measurement space L/a/b, it has a value delta E of <1.7. In this test, it should be taken into account that at a delta E value of ≥3, the viewer will see a subjectively perceivable color change. Perceivable yellowing that is disturbing to the viewer can therefore be ruled out even after decades. It should be taken into account here that yellowing is to be understood as a significant color difference that is perceived by the viewer to be disturbing and unsightly. Advantageously, delta E is to be understood as the change in color, also referred to as the color difference.

These data were determined using a CM-2600d spectrophotometer from Konica Minolta (illuminant D65, SCE, 10°), wherein the values were determined on a hue with the color values L=44, a=−1.35 and b=−2.35. Advantageously, the tolerance in this case is L=+1.5, a=+0.7, b=+1.0.

Furthermore, it has been found to be advantageous if the top layer has a layer thickness in the cured state in the range of 40 to 150 μm. At the same time, it has been found that despite its low layer thickness, the top layer described here, as mentioned above, can be produced free of defects. In particular, the resulting cured top layer is free of fat spots, free of thick areas, free of folds, free of undercuring and free of matting effects and the like.

For the first time, it is possible to produce such a top layer in the layer thicknesses specified herein without defects over a length of 180 m in a continuous process.

The extremely low layer thickness makes it possible for the plastic composite products produced, with the same thickness, to have a higher glass content and thus also better mechanical properties than it has been possible to date in the prior art. Alternatively, it is also conceivable to save weight by reducing layer thickness.

Further advantageous embodiments are discussed in the dependent claims below.

In a further advantageous embodiment, it has been found to be advantageous for the top layer to comprise at least one deep-curing UV initiator. This has been found to be advantageous because on irradiation with UV radiation, the crosslinking process does not begin at the surface of the material, but in the volume below. Consequently, it is possible for the first time for the exposed surface that is directly irradiated with UV radiation to be incompletely cured. In addition, it has been found to be advantageous if the UV initiator is susceptible to oxygen inhibition, as the reaction is then slowed down. The free radicals formed are bound by the radical properties of the atmospheric oxygen before they can begin polymerization. The slowed reaction at the boundary layer makes the chemical crosslinking of the top layer comprising the matrix layer possible and advantageously results in a permanent composite of the matrix layer and top layer. The plastic composite described herein shows highly favorable binding properties between the top layer and the matrix layer. Adhesion loss, for example in the form of flaking or cracks, is not observed.

The UV initiator is required to initiate the radical polymerization during UV irradiation. It should be pointed out here that without UV irradiation, no crosslinking takes place. This proves to be advantageous in particular in storage and preparation of the upper material, as this allows it to be used for a long period of time despite mixing. Consequently, with the exclusion of UV rays, particularly long pot lives of several days to several months, advantageously up to 12 months, are achieved. “Pot life” is generally understood to be the period of time in which two or more mutually reactive components, for example resin and a curing agent, remain usable after being mixed. The top layer is configured to be deep-curing.

In a further advantageous embodiment, it has been found to be advantageous for the deep-curing UV initiator to comprise at least one phosphine oxide group. Here, in particular, phosphine oxides, for example diphenyl(2,4,6-trimethylbenzoyl) phosphine oxide (Omnirad TPO), ethyl(2,4,6-trimethylbenzoyl)phenylphosphinate (Omnirad TPO-L) or phenyl-bis(2,4,6-trimethylbenzoyl) phosphine oxide (Omnirad 819) have been found to be advantageous. This phosphine oxide group can be cured and crosslinked with long-wave UV radiation. On the exposed upper side, from which the UV radiation is introduced, the radicals formed are bound with atmospheric oxygen. The crosslinking is inhibited. Away from the exposed upper side, i.e. in the top layer volume underneath, crosslinking can take place significantly more favorably. For this reason, the phosphine oxide group introduced here in the top layer can undergo deep curing.

Furthermore, a deep-curing UV initiator, advantageously selected from the above-mentioned phosphine oxide group, has proven to be advantageous if the top layer comprises at least one further additive, for example a color pigment. Due to the long-wave excitation of the UV initiators disclosed herein, UV radiation introduced into the top layer is not absorbed by the color pigment and is therefore completely available for the polymerization of the top layer. In this manner, for the first time, a colored top layer can be crosslinked and cured to a high level of quality.

TPO-L has proven to be a particularly advantageous UV initiator, as this composition can already be provided in the liquid aggregate state. The two other compositions Omnirad 819 and Omnirad TPO are present in the solid aggregate state and must first be converted to the liquid aggregate state before use.

If the applied top layer is then exposed to at least one UV irradiation source, a curing gradient is formed. Directly on the surface of the top layer at the site of UV radiation impact, the crosslinking conversion is low, and it increases in the direction of the layer thickness progression. This means that the deeper regions of the top layer show a significantly greater degree of conversion during crosslinking.

Furthermore, an advantage of deep curing is that during the production process, the top layer remains flat. For example, if deep curing were not carried out to a sufficient degree, this would result in delamination of the top layer, requiring production to be interrupted, because a top layer with corrugations and delamination would be unusable. Insufficient deep curing and thus unusable top layers can be observed for example with initiators such as methyl benzoylformate or 1-hydroxycyclohexyl phenyl ketone, as well as in use of acetophenones or benzophenones.

In a further advantageous embodiment, the acrylate-based resin of the top layer can be a urethane acrylate resin. This can be referred to as the base layer material of the top layer. It shows an aliphatic basic structure comprising a plurality of carbamate groups. The basic structure further comprises at least one methacrylate group and/or an acrylate group as a free end group. The crosslinking takes place via this group. As a result of the crosslinking, a urethane acrylate network is formed in which the individual oligomers with the aliphatic basic structure, the carbamate groups arranged thereon, and the at least one crosslinking group interact with one another. The stability of the network is maintained via the crosslinkable acrylate groups and/or methacrylate groups of the oligomers. The carbamate groups of an oligomer can reversibly bond to other carbamate groups of other oligomers via hydrogen bonds. This combination allows the top layer to remain sufficiently flexible even after crosslinking, and cracks and fractures are prevented.

Furthermore, the at least one acrylate-based resin is advantageously configured to be photoinitiable, so that crosslinking takes place by radical polymerization under UV irradiation. In addition, this is advantageous in that the crosslinking can take place in extremely short time intervals, with a homogeneous surface structure and overall structure of the top layer being simultaneously achieved. The top layer to be cured by means of UV irradiation is exposed to UV radiation in the wavelength range of 250-500 nm for a time interval of 3-30 seconds, more advantageously 5 to 15 seconds, and even more advantageously 5 seconds, 6 seconds, 7 seconds, 8 seconds, 9 seconds, 10 seconds, 11 seconds, 12 seconds, 13 seconds, 14 seconds, or 15 seconds. Advantageously, a metal-doped irradiation source, such as e.g. a gallium-doped or iron-doped mercury lamp that emits a dose of 400 mJ/cm²±10%, can be used for this purpose. This extremely short time interval is sufficient to allow deep-curing crosslinking of the top layer. This makes particularly fast crosslinking possible, which means that a particularly large amount of time is saved throughout the entire production process. The time saving is accompanied by a cost reduction, and market success can be increased.

In a further advantageous embodiment, the material of the top layer can be mixed with further reactive monomers. Such monomers cam be 1,6-hexanediol diacrylate (HDDA) and/or trimethylolpropane triacrylate (TMPTA). By adding reactive monomers to the acrylate-based resin, the properties of the top layer, particularly with respect to flexibility, can be modified in a targeted manner. Thus, the flexibility of the top layer in the cured state can be increased by adding 1,6-hexanediol diacrylate (HDDA) and/or trimethylolpropane triacrylate (TMPTA). In this way, the top layer is less susceptible to deep scratches and damage. 1,6-hexanediol diacrylate (HDDA) and/or trimethylolpropane triacrylate (TMPTA) can be understood to be reactive solvents.

In a further advantageous embodiment, the matrix layer can comprise at least one type of fibers as a reinforcing material. The selected reinforcing material and thus the type of fibers advantageously depends on the planned use of the produced plastic composite. For example, carbon fibers, glass fibers, polymer fibers, basalt fibers and/or combinations thereof are therefore possible. In addition, natural fibers such as e.g. flax fibers can also be used. The fibers introduced into the matrix layer serve the purpose of reinforcing the matrix layer when it is subjected to external forces, for example due to torsional forces resulting from the operation of recreational vehicles or commercial vehicles, through impact loads at camp sites, in road traffic, or due to weather events such as hail or strong winds.

For example, the fibers can be embedded in a matrix layer as glass fibers, chopped glass mats, glass roving fabrics, multiaxial fabrics and/or combinations thereof. Glass fibers have been found to be particularly advantageous as a reinforcing material because of their simple processing and high reinforcing properties.

Particularly advantageously, the reinforcing material introduced is a semifinished textile product. These can for example be chopped glass mats, glass roving fabrics, multiaxial fabrics and/or combinations thereof.

For example, in producing the plastic composite described here, if a chopped glass mat is used as a reinforcing material, it can be unwound continuously during the production process and first placed from above on the liquid matrix layer material. Due to the capillary forces, the chopped glass mat is thoroughly wetted and/or soaked by the still-liquid matrix layer. Additional impregnation aids can optionally be provided in order to accelerate and improve impregnation. The chopped glass mat is absorbed by the still-liquid matrix layer.

It is also conceivable, depending on the use of the finished plastic composite, that for example, several identical and/or several different fiber reinforcements materials are embedded in the matrix layer. For example, it is conceivable that several chopped glass mats, several multiaxial fabrics and/or several glass roving fabrics are embedded in the matrix layer. In this way, the reinforcing effect exerted by the respective reinforcing material can be adjusted in a targeted manner.

Of course, it is also conceivable for more than one chopped glass mat to be introduced into the matrix layer, which is still to be cured. Advantageously, the chopped glass mats are applied in temporally staggered fashion one after the other and from above. Temporally staggered application of several chopped glass mats is advantageous in that the still-liquid resin remains intact as a layer and the chopped glass mats can be impregnated one after the other via the capillary forces.

The statistical arrangement of the glass fibers in the length and width of the chopped strand mat results in an open structure. It is precisely this structure that is advantageous for allowing the chopped glass mat to dip into the still-liquid matrix layer material. If the structure were too close-meshed, this would result in air inclusions in the layer structure. With the highly open structure of the chopped glass mats used here, the impregnation thereof is supported, and pore formation due to air inclusions is prevented. The chopped glass mats are applied from above to the liquid matrix layer, which has already been applied and is still liquid, so the chopped glass mats can dip into the liquid matrix material.

On the other hand, if a chopped glass mat with four times the thickness of a conventional chopped glass mat was applied, the application from above into the still-liquid matrix layer would displace the still-liquid resin of the matrix layer, destroying the layer and making it completely unusable.

It has been found to be particularly advantageous if the chopped glass mats used here are provided as continuous mats. This then advantageously provides continuous long fibers that are deposited statistically over the width and length of the mat. In this way, an open structure is produced. It is precisely this structure that is advantageous for allowing the chopped glass mat to dip into the still-liquid matrix layer material. If the structure were too close-meshed, air inclusions would occur in the layer structure. The highly open structure of the chopped glass mats used here supports impregnation, and pore formation due to air inclusions is prevented.

Advantageously, the finished plastic composite has a glass content of 15 to 70 wt % based on the total weight of the cured plastic composite, i.e. 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, or 70 wt %, with all of these values being based on the total weight of the cured plastic composite. The intermediate values are also disclosed. An even more advantageous glass content is 15 to 65 wt % based on the total weight of the cured plastic composite, i.e. 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, or 65 wt %, with all of these values being based on the total weight of the cured plastic composite. The intermediate values are also disclosed. This ensures that the matrix layer is sufficiently reinforced while simultaneously maintaining corresponding flexibility. This is particularly necessary during assembly, as the cut edges would otherwise splinter on cutting of the continuous plastic composite.

If the matrix material is cured, the fibers arranged therein are correspondingly fixed. This fixes the entire structure of the matrix material. Reshaping is no longer possible. In particular, because of the fixing of the fibers in the matrix layer, the fiber reinforcement is configured in such a way that mechanical stress is transferred to the fibers, so that in the resulting plastic composite, high specific stiffness and high mechanical strength, which can also be understood as high mechanical stability, can be achieved.

Chopped glass mats with a fiber fineness of 12 to 30 tex have been found to be particularly advantageous. In use of this fiber fineness, a high level of surface evenness of the matrix layer can be achieved.

In a further advantageous embodiment, at least one separating layer can be arranged between the top layer and matrix layer. This at least one separating layer can be configured, for example, as a glass fleece. The purpose of this separating layer is to provide separation between the top layer and the fibers of the matrix layer. On the one hand, in the production process, this can prevent fibers from damaging the top layer, which is only deep-cured, causing significant defects.

In addition, the fibers embedded in the matrix layer at the interface to the top layer form a structure that is referred to as a fiber imprint. The fiber imprint is visible in the finished plastic composite through the top layer. In use of the plastic composite in the area of camping in particular, this fiber imprint is highly undesirable. As stringent quality requirements are placed on the wall elements of campers and/or RVs, a visible fiber imprint constitutes a reduction in quality or a defect. If the glass fleece advantageously has a thickness in the range of 150-250 μm, the fiber imprint visible through the top layer is spanned, and its optical visibility is significantly reduced. Advantageously, the glass fleece has a basis weight in the range of 15 to 35 gr/m². The above-mentioned glass content in the finished plastic composite is to be understood as the total glass content. This includes the glass content of one or more glass fleeces.

The at least one separating layer is therefore used in order to create an optical separation between the top layer and fibers in the matrix layer. At the same time, the fiber imprint is stretched and thus reduced. The plastic composite described here, when used as a camper wall element and/or mobile home wall element, comprises at least one fiber-imprint-reducing separating layer.

In a further advantageous embodiment, the matrix layer is composed of an unsaturated polyester resin and/or a vinyl ester resin, both of which comprise unsaturated groups. In order to initiate the radical polymerization of the unsaturated groups, the matrix material advantageously comprises at least one organic peroxide, which decomposes on exposure to temperature. In addition, a crosslinking agent can also be provided in the matrix material which induces crosslinking of the respective resin. As an example of such a crosslinking agent, styrene can be used.

In addition to its function as a crosslinking agent, styrene also acts as a solvent for the respective resin. For example, if an unsaturated polyester resin and/or vinyl ester resin is used, covalent bonds can be formed with the unsaturated aliphatic resin of the top layer.

In a further exemplary embodiment of the present invention, the matrix material can also be an epoxy resin and/or a polyurethane resin. The two resins comprise no unsaturated groups. In using this type of resins, it is necessary to initiate polyaddition as a polymerization reaction. In this case, any type of molecule with reactive oxygen can be used for crosslinking the resin. This includes for example amines, acids, acid anhydrides, alcohols and/or thiols and combinations thereof. If an epoxy resin and/or a polyurethane resin is used as a matrix material, it will undergo non-covalent bonding to the top layer. This occurs because the two resin materials of the two layers are at least partially dissolved at the interface, which leads to a non-covalent interaction between the top layer and the matrix layer.

In a further advantageous embodiment, the top layer and/or the matrix layer can comprise at least one further additive. The additives can advantageously be selected from the group of coloring additives, effect pigments, UV initiators, UV stabilizers, free radical scavengers and/or a combination thereof.

In an exemplary embodiment, it has been found to be advantageous if the matrix layer and the top layer each comprises at least one coloring additive. Thus it is conceivable that advantageously, the top layer and matrix layer each comprises at least one coloring pigment or pigment mixture. Advantageously, the top layer and matrix layer comprise the same coloring pigment. Of course, as this is not to be construed as restrictive, it is also conceivable that pigment mixtures can be used. In this example, the same pigment mixture can be added to the top layer and the matrix layer. The result is that the plastic composite is dyed throughout, so that any possible outer damage to the top layer, such as e.g. a scratch, is virtually invisible.

Consequently, with the at least one coloring pigment in the top layer and matrix layer or with at least one pigment mixture in the top layer and matrix layer, minor damage to the plastic composite can be optically compensated for to an outstanding degree. Advantageously, the finished plastic composite, i.e. the two layers thereof, is/are colored using the same coloring pigment or pigment mixtures.

Depending on the use of the plastic composite, for example, titanium dioxide produces a particularly favorable white coloring effect. In this way, the layer containing the titanium dioxide is colored white. In addition to titanium dioxide, barium sulfate or zinc sulfide should also be mentioned as coloring pigments. These also produce white coloring of the respective layer.

Of course, as this is not to be construed as restrictive, it is also conceivable that one and/or both layers are colored black by adding carbon, for example.

In addition, it is also conceivable to color the matrix layer and/or the top layer in a targeted manner by adding further coloring pigments and/or dyes according to the planned use. Here, for example, blue dyes have also been found to be advantageous, as they can already be provided in the matrix material and/or top layer material kept on hand. Mixtures of dyes and color pigments and/or of color pigments with one another are also possible. Thus, for example, a gray matrix layer and/or top layer can be produced by mixing titanium dioxide and carbon. The mixing ratio depends on the desired gray level. Another combination possibility is the use of a pigment mixture containing at least titanium dioxide and phthalocyanine blue. In addition, it is also conceivable to use iron oxide yellow or iron oxide red as pigments individually or as mixtures with one another or with titanium dioxide.

The coloring of the two layers here is to be understood as an example, but it is particularly advantageous. It is also conceivable, depending on the application, to add different coloring additives to the top layer and the matrix layer.

If color pigments are used, it has been found to be advantageous to add them in the range of 1 to 15 phr based on the respective layer in the liquid state, i.e. 1 phr, 1.1 phr, 1.2 phr, 1.3 phr, 1.4 phr, 1.5 phr, 1.6 phr, 1.7 phr, 1.8 phr, 1.9 phr, 2.0 phr, 2.1 phr, 2.2 phr, 2.3 phr, 2.4 phr, 2.5 phr, 2.6 phr, 2.7 phr, 2.8 phr, 2.9 phr, 3.0 phr, 3.1 phr, 3.2 phr, 3.3 phr, 3.4 phr, 3.5 phr, 3.6 phr, 3.7 phr, 3.8 phr, 3.9 phr, 4.0 phr, 4.1 phr, 4.2 phr, 4.3 phr, 4.4 phr, 4.5 phr, 4.6 phr, 4.7 phr, 4.8 phr, 4.9 phr, 5.0 phr, 5.1 phr, 5.2 phr, 5.3 phr, 5.4 phr, 5.5 phr, 5.6 phr, 5.7 phr, 5.8 phr, 5.9 phr, 6.0 phr, 6.1 phr, 6.2 phr, 6.3 phr, 6.4 phr, 6.5 phr, 6.6 phr, 6.7 phr, 6.8 phr, 6.9 phr, 7.0 phr, 7.1 phr, 7.2 phr, 7.3 phr, 7.4 phr, 7.5 phr, 7.6 phr, 7.7 phr, 7.8 phr, 7.9 phr, 8.0 phr, 8.1 phr, 8.2 phr, 8.3 phr, 8.4 phr, 8.5 phr, 8.6 phr, 8.7 phr, 8.8 phr, 8.9 phr, 9.0 phr, 9.1 phr, 9.2 phr, 9.3 phr, 9.4 phr, 9.5 phr, 9.6 phr, 9.7 phr, 9.8 phr, 9.9 phr, 10.0 phr, 10.1 phr, 10.2 phr, 10.3 phr, 10.4 phr, 10.5 phr, 10.6 phr, 10.7 phr, 10.8 phr, 10.9 phr, 11.0 phr, 11.1 phr, 11.2 phr, 11.3 phr, 11.4 phr, 11.5 phr, 11.6 phr, 11.7 phr, 11.8 phr, 11.9 phr, 12.0 phr, 12.1 phr, 12.2 phr, 12.3 phr, 12.4 phr, 12.5 phr, 12.6 phr, 12.7 phr, 12.8 phr, 12.9 phr, 13.0 phr, 13.1 phr, 13.2 phr, 13.3 phr, 13.4 phr, 13.5 phr, 13.6 phr, 13.7 phr, 13.8 phr, 13.9 phr, 14.0 phr, 14.1 phr, 14.2 phr, 14.3 phr, 14.4 phr, 14.5 phr, 14.6 phr, 14.7 phr, 14.8 phr, 14.9 phr, or 15 phr, with all of the above values being based on the respective layer in the liquid state. The intermediate values are also disclosed. Color pigments added in this range to the top layer provide sufficient protection against yellowing of the matrix layer. In addition, the top layer is also configured to be deep-curable.

The addition of titanium dioxide to the top layer has been found to particularly advantageous if white coloring of the plastic composite is desired. In order to ensure sufficient curing of the top layer, and in order to prevent folds during curing, it has been found to be advantageous to select the pigment content of titanium dioxide in the range of 1.5-8 phr, more advantageously 1.5 phr, 1.6 phr, 1.7 phr, 1.8 phr, 1.9 phr, 2.0 phr, 2.1 phr, 2.2 phr, 2.3 phr, 2.4 phr, 2.5 phr, 2.6 phr, 2.7 phr, 2.8 phr, 2.9 phr, 3.0 phr, 3.1 phr, 3.2 phr, 3.3 phr, 3.4 phr, 3.5 phr, 3.6 phr, 3.7 phr, 3.8 phr, 3.9 phr, 4.0 phr, 4.1 phr, 4.2 phr, 4.3 phr, 4.4 phr, 4.5 phr, 4.6 phr, 4.7 phr, 4.8 phr, 4.9 phr, 5.0 phr, 5.1 phr, 5.2 phr, 5.3 phr, 5.4 phr, 5.5 phr, 5.6 phr, 5.7 phr, 5.8 phr, 5.9 phr, 6.0 phr, 6.1 phr, 6.2 phr, 6.3 phr, 6.4 phr, 6.5 phr, 6.6 phr, 6.7 phr, 6.8 phr, 6.9 phr, 7.0 phr, 7.1 phr, 7.2 phr, 7.3 phr, 7.4 phr, 7.5 phr, 7.6 phr, 7.7 phr, 7.8 phr, 7.9 phr, or 8.0 phr. The intermediate values are also disclosed. For example, if a titanium dioxide content of greater than 8 phr is used, the curing of the top layer is adversely affected. Precuring of the top layer occurs, causing the surface to fold up while the underlying substrate remains liquid. For this reason, a titanium dioxide content of greater than 8 phr is to be avoided. A titanium dioxide content of less than 1.5 phr is too low to allow sufficient coloring to occur. The advantage of titanium dioxide, as well as other coloring additives, is that the pigment itself and/or its absorbent properties protect the underlying matrix layer and prevent it from yellowing. The coloring additives, such as e.g. color pigments, effect pigments and/or dyes, are thus configured as UV reflectors and/or UV filters for the underlying non-UV-resistant matrix layer.

The plastic composite disclosed shows in a particularly advantageous embodiment that the liquid top layer can have a color pigment content of 3 to 8 phr, more advantageously 3.0 phr, 3.1 phr, 3.2 phr, 3.3 phr, 3.4 phr, 3.5 phr, 3.6 phr, 3.7 phr, 3.8 phr, 3.9 phr, 4.0 phr, 4.1 phr, 4.2 phr, 4.3 phr, 4.4 phr, 4.5 phr, 4.6 phr, 4.7 phr, 4.8 phr, 4.9 phr, 5.0 phr, 5.1 phr, 5.2 phr, 5.3 phr, 5.4 phr, 5.5 phr, 5.6 phr, 5.7 phr, 5.8 phr, 5.9 phr, 6.0 phr, 6.1 phr, 6.2 phr, 6.3 phr, 6.4 phr, 6.5 phr, 6.6 phr, 6.7 phr, 6.8 phr, 6.9 phr, 7.0 phr, 7.1 phr, 7.2 phr, 7.3 phr, 7.4 phr, 7.5 phr, 7.6 phr, 7.7 phr, 7.8 phr, 7.9 phr, or 8.0 phr, with the intermediate values also being disclosed, and shows for the first time that by simultaneously providing a deep-curing UV initiator, which the top layer also contains at least, a top layer colored with color pigment can also be selectively cured and crosslinked for the first time. If conventional UV initiators, i.e. non-deep-curing UV initiators, were used, the incident UV radiation would be almost completely reflected by the color pigment, and no crosslinking would take place. High-quality curing of a colored top layer has therefore been implemented for the first time in combination with at least one deep-curing UV initiator.

For example, if the top layer has a titanium dioxide content of 3-8 phr, i.e. 3.0 phr, 3.1 phr, 3.2 phr, 3.3 phr, 3.4 phr, 3.5 phr, 3.6 phr, 3.7 phr, 3.8 phr, 3.9 phr, 4.0 phr, 4.1 phr, 4.2 phr, 4.3 phr, 4.4 phr, 4.5 phr, 4.6 phr, 4.7 phr, 4.8 phr, 4.9 phr, 5.0 phr, 5.1 phr, 5.2 phr, 5.3 phr, 5.4 phr, 5.5 phr, 5.6 phr, 5.7 phr, 5.8 phr, 5.9 phr, 6.0 phr, 6.1 phr, 6.2 phr, 6.3 phr, 6.4 phr, 6.5 phr, 6.6 phr, 6.7 phr, 6.8 phr, 6.9 phr, 7.0 phr, 7.1 phr, 7.2 phr, 7.3 phr, 7.4 phr, 7.5 phr, 7.6 phr, 7.7 phr, 7.8 phr, 7.9 phr, or 8.0 phr, with the intermediate values also being disclosed, it has also been found to be advantageous to provide the matrix layer with at least one, advantageously the same, coloring pigment. Because of the low layer thickness of the top layer in combination with the titanium dioxide content in the range of 3-8 phr, i.e. 3.0 phr, 3.1 phr, 3.2 phr, 3.3 phr, 3.4 phr, 3.5 phr, 3.6 phr, 3.7 phr, 3.8 phr, 3.9 phr, 4.0 phr, 4.1 phr, 4.2 phr, 4.3 phr, 4.4 phr, 4.5 phr, 4.6 phr, 4.7 phr, 4.8 phr, 4.9 phr, 5.0 phr, 5.1 phr, 5.2 phr, 5.3 phr, 5.4 phr, 5.5 phr, 5.6 phr, 5.7 phr, 5.8 phr, 5.9 phr, 6.0 phr, 6.1 phr, 6.2 phr, 6.3 phr, 6.4 phr, 6.5 phr, 6.6 phr, 6.7 phr, 6.8 phr, 6.9 phr, 7.0 phr, 7.1 phr, 7.2 phr, 7.3 phr, 7.4 phr, 7.5 phr, 7.6 phr, 7.7 phr, 7.8 phr, 7.9 phr, or 8.0 phr, the top layer shows transparency. This means that 100% opacity cannot be produced. For this reason, it has been found to be advantageous to also color the matrix layer correspondingly. The result is a white plastic composite that is dyed throughout. This in turn has the advantage that, as mentioned above, scratches are less visible overall and even deep scratches do not stand out optically.

This is also particularly important in the camping industry, as the plastic composites used to date undergo significant yellowing over time, resulting in a significant reduction and deterioration in resale value, and of course optical appearance.

At the same time, it has been found that the low content of at least one coloring pigment in the top layer has no substantial effect on the curing thereof or the subsequent optical effect of the top layer.

Furthermore, at least one effect pigment can also be used in the top layer and/or matrix layer. For example, it is conceivable to provide at least one effect pigment in the top layer. In this way, for example, the reflection thereof can be sharply increased, giving rise to a glittering optical effect.

Examples of such effect pigments that have been found to be advantageous include glass particles, mica and/or layered silicate particles. These can optionally be coated with at least one or more of the following oxides: titanium dioxide, iron oxide, silicon dioxide, and/or tin oxide.

Furthermore, it is conceivable to select the effect pigments from aluminum particles, copper particles, brass particles, or bronze particles and/or combinations thereof. In this way, special metallic effects can be produced. In addition, it has been found that by using particles in the top layer, the scattering effect thereof can be exploited, such that incident UV radiation is reflected by the top layer, more precisely by the particles introduced therein. This provides additional UV protection of the underlying matrix layer, thus preventing it from yellowing.

Particularly advantageously, the effect pigments have an average particle size in the range of 10-100 μm. The particle size of the effect pigments is defined as the d₅₀ value, which is determined by laser granulometry. The d₅₀ value indicates the average particle size of the effect pigments, wherein 50% of the effect pigment particles in the sample examined are smaller than the specified value.

Advantageously, the coloring additives, effect pigments and dyes of any type may be combined as coloring additives. These can be contained in the top layer and/or in the matrix layer.

Of course, the exemplary embodiments herein are not to construed as restrictive. Combinations of effect pigment, for example mica, with color pigment, for example titanium dioxide, in mixing ratios of 1 to 1, 1 to 2, or 1 to 3 are also advantageous. In this case, top layers with optical effects and additional UV protection can be provided.

Furthermore, it is conceivable that the top layer can comprise, as further additives, one or more UV stabilizers, UV initiators and/or one or more free radical scavengers. In this manner, depending on the selection and content, the UV and weather resistance of the entire plastic composite can be improved.

In a further advantageous embodiment, the top layer can have a layer thickness in the cured state in the range of 50 μm, 55 μm, 60 μm, 65 μm, 70 μm, 75 μm, 80 μm, 85 μm, 90 μm, 95 μm, 100 μm, 105 μm, or 110 μm and all ranges in between. Reduced layer thicknesses result in reduced material consumption and more rapid curing. At the same time, it has been found that the top layer described here, despite its low layer thickness, can as mentioned above be produced free of defects. In particular, the resulting cured top layer is free of fat spots, free of thick areas, free of folds, free of undercuring and free of matting effects and the like. It is possible for the first time to provide such a top layer in the layer thicknesses mentioned here free of defects over a length of 180 m in a continuous process. The extremely low layer thickness makes it possible for the plastic composite products produced to have a higher glass content at the same thickness and thus also better mechanical properties than were possible in the prior art. Alternatively, it is also conceivable to save weight by reducing the layer thickness.

In addition, it is also conceivable for the plastic composite to comprise a higher glass content of up to 70 wt % based on the total mass of the cured plastic composite, more advantageously at least 65 wt % based on the total mass of the cured plastic composite. It is thus possible for a plastic composite produced in this manner with a high glass content of up to 70 wt % based on the total mass of the cured plastic composite to have a tensile strength of about 400 N/mm² (DIN EN ISO 527-4/2/2) and a tensile modulus of about 23000 N/mm² (DIN EN ISO 527-4/2/2).

In a further advantageous embodiment, the top layer, which is advantageously configured as a urethane acrylate, shows a maximum 2 wt % loss in the cured state compared to the liquid state. This loss is due to the reaction solvent, for example HDDA. This is released during curing. The extremely low shrinkage of the top layer is particularly advantageous, as this allows material to be saved, which reduces the production costs.

In a further advantageous embodiment, the top layer, after a 3000-hour Xeno-test, a test method according to DIN EN ISO 4892-2-A1, shows a gloss retention of at least 80%. This value of at least 80% refers to the original gloss level of 100% before the beginning of the test. This test method is also known as the Accelerated Weathering Test according to DIN EN ISO 4892-2-A1. The gloss level is measured here with a gloss meter (from BYK micro-TRI-gloss) using a measuring angle of 20°.

It has also been shown to be advantageous that the urethane acrylate used as the top layer of the plastic composite can be colored to a certain degree with color particles, wherein the curability by UV radiation is being maintained.

It has also been shown to be advantageous that in outdoor applications, these coloring additives block the majority of UV radiation, advantageously >95% of the incident radiation, to such an extent that it does not reach the underlying matrix layer with the fiber reinforcement. In this regard, see Table 1, in which a gallium-doped mercury lamp was used as a UV irradiation source. The top layer comprising varying pigment contents was placed on a Power Puck 2 radiometer and passed under at UV lamp at 120 W/cm and 10 m/min.

TABLE 1

| | | UV puck | UV puck | UV puck | UV puck |
|---|---|---|---|---|---|
| | | (UV dose) | (UV dose) | (UV dose) | (UV dose) |
| | | without | 0.75 wt % | 1.50 wt % | 3.0 wt % |
| | UV puck | pigment | pigment | pigment | pigment |
| UV A | 255 | 64 | 11 | 0 | 0 |
| | mJ/cm²: | mJ/cm²: | mJ/cm²: | | |
| UV B | 300 | 7 | 0 | 0 | 0 |
| | mJ/cm²: | mJ/cm²: | | | |
| UV C | 65 | 1 | 0 | 0 | 0 |
| | mJ/cm²: | mJ/cm²: | | | |

As can be seen from Table 1, UV protection of the underlying matrix layer against yellowing begins with addition to the top layer of 1.5 wt % pigment based on the total formulation of the top layer in the cured state, for example titanium dioxide. On irradiation through the top layer, no UV radiation is detected under the top layer. When only 0.75 wt % of pigment is added in the cured state based on the total formulation of the top layer, it can be seen that the reduced UV radiation is allowed to pass through the top layer. In the long term, this would also lead to yellowing of the underlying non-UV-resistant matrix layer.

The matrix layer of the plastic composite described herein is configured to be free of UV stabilizers, so that on UV irradiation, it quickly shows visible yellow discoloration. It has been shown that even UV-stabilized matrix systems tend to show visible yellowing. This effect is based on the high content of aromatic groups in the matrix resins. This color change is perceived to be disturbing by the viewer. The originally white color has turned yellow and is also perceived as yellow by the viewer. So-called yellowing has occurred.

With the present invention, a total system in the form of a plastic composite of fiber-reinforced plastic, for the first time, selection of virtually any color desired is possible, as well as maximum UV stability that prevents yellowing over a period of years. The plastic composite is exposed to UV radiation in a predetermined dose and over a specified time period in the Xeno-test, a test method according to DIN EN ISO 4892-2-A1, which is also referred to as the Accelerated Weathering Test Method according to DIN EN ISO 4892-2-A1. When this test method according to DIN EN ISO 4892-2-A1 is carried out for 3000 hours, the top layer of the plastic composite disclosed here shows a gloss retention of at least 80%. This value of 80% is relative to the original gloss level of 100%.

It has also been shown that the top layer of the plastic composite described here, in a Xeno-test, a test method according to DIN EN ISO 4892-2-A1, also known as the Accelerated Weathering Test according to DIN EN ISO 4892-2-A1, shows a loss of gloss of <10% relative to the original gloss level of 100% after over 1000 hours of exposure. When the test method according to DIN EN ISO 4892-2-A1, also known as the Accelerated Weathering Test according to DIN EN ISO 4892-2-A1, is carried out for 7000 hours, which corresponds to outdoor weathering for 15 to 20 years in the central European climate, the top layer of the plastic composite described herein shows a loss of gloss of only <30% relative to the original gloss level of 100%. This means that the plastic composite described herein is configured to show particularly high quality and long-lasting quality for outdoor use. Even after 15-20 years, the gloss of the top layer is substantially retained, so that the plastic composite can continue to be used and does not have to be exchanged and replaced due to cloudiness or dullness.

These data were determined using a CM-2600d spectrophotometer from Konica Minolta (illuminant D65, measuring method SCE, viewer) 10°, wherein the measured color values are L=44, a=−1.35 and b=−2.35. Advantageously, the tolerance in this case is L=+1.5, a=+0.7, b=+1.0.

Particularly advantageously, the plastic composite described herein is produced in a continuous process in a width of 1.5 m-4 m, more advantageously 1.5 m, 1.6 m, 1.7 m, 1.8 m, 1.9 m, 2.0 m, 2.1 m, 2.2 m, 2.3 m, 2.4 m, 2.5 m, 2.6 m, 2.7 m, 2.8 m, 2.9 m, 3.0 m, 3.1 m, 3.2 m, 3.3 m, 3.4 m, 3.5 m, 3.6 m, 3.7 m, 3.8 m, 3.9 m, 4.0 m and a length of up to 250 m in a continuous process. This 250 m length is due to the assembly of the pre-rolled plastic composite. The production process itself is configured as a continuous process.

In a further advantageous embodiment and advantageous alternative for determining thermal deformation resistance, resins have been found to be advantageous for the matrix material that provide a glass transition temperature (T_{g}) of the plastic composite described herein of at least 90° C. Resins having a T_{g} of between 90-120° C., i.e. 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., or 120° C. have been found to be particularly suitable, with all intermediate values also being disclosed. Advantageous examples of such resins are orthophthalic acid-based, isophthalic acid-based and/or terephthalic acid-based UP resins, epoxy resins and/or polyurethane resins and mixtures thereof. Precisely these glass transition temperatures are advantageous, as they allow thermal deformations due to heating in daylight to be avoided. At the same time, at these temperatures, favorable evenness of the plastic composite can be achieved.

The glass transition temperature is determined by dynamic mechanical analysis (DMA). The measurements are carried out with a model AR2000 rheometer from TA Instruments and processed using the program Rheology Advantage. Measurement parameters are free clamping length 40-44 mm; temperature ramp 0-120° C.; deformation 0.1%; excitation frequency 1 Hz; temperature ramp 3K/min. The glass transition temperature T_{g} is located at the maximum in the tan & curve.

In a further advantageous embodiment, coloring pigments of other colors can also be used. For example, these produce a hue with L=90.09; a=−2.02 and b=3.30, wherein the standard tolerances of L=+1.5, a=+0.7, b=+1.0 apply. Advantageously, this can be configured as a pigment mixture that can comprise at least titanium dioxide and phthalocyanine blue. In carrying out the Accelerated Weathering Test according to DIN EN ISO 4892-2-A1, a gloss retention of at least 80% of the original gloss level of 100% was measured after 3000 hours. Furthermore, the color change delta E of <1.2 was determined under these conditions.

These data were determined using a CM-2600d spectrophotometer from Konica Minolta (illuminant D65, measuring method SCE, viewer) 10°. The gloss level is determined by measuring the ratio of incident light to light reflected from the surface, taking into account the angle of specular reflection, using a reflectometer. The measuring device used here was a BYK-Gardner “tri-gloss” reflectometer with a measuring angle of 20°.

Furthermore, the invention also relates to a production process for producing the plastic composite as claimed in claim 9.

The method has at least the following steps:
a. applying the top layer material to a carrier surface;
b. forming the top layer material into a layer on the carrier surface;
c. exposing the resulting top layer to UV radiation, so that the top layer undergoes deep curing;
d. applying the matrix material to form the matrix layer;
e. applying fiber material to the matrix layer, wherein the fiber material sinks into the still-liquid matrix layer and/or the fiber material is enclosed by the still-liquid matrix layer due to capillary forces;
f. curing of the matrix layer;
g. removing the carrier material to obtain the fiber-reinforced, multilayer plastic composite as the end product.

In a first step a), the liquid top layer material to be cured is applied to a carrier surface. In an advantageous exemplary embodiment, it has been found to be advantageous for the carrier surface itself to be configured as a film. In particular, it has been found to be advantageous to use a polyethylene terephthalate (PET) film as a carrier surface to which the top layer material that is still to be cured is applied. Polyethylene terephthalate is advantageous in that as the top layer material does not form a permanent adhesive bond with it, in the subsequent production process, the film is correspondingly light and can be removed again without destroying the top layer.

Advantageously, it has also been shown to be advantageous for the PET film to have a film thickness in the range of 10-350 μm. The top layer material to be applied is advantageously configured as an unsaturated, acrylate-based aliphatic resin. Furthermore, additives can be provided, such as e.g. coloring additives, UV stabilizers, UV initiators, reaction accelerators and free radical scavengers and/or combinations thereof. These additives are advantageously added to the top layer material before application to the carrier surface.

Of course, the configuration of the carrier surface as a PET film is not to be construed as restrictive, so it is also conceivable for other carrier surfaces to be used. For example, a possible geometric shape could also be used as a carrier surface. It is also conceivable that belt-like transport surfaces are used.

In order to remove possible creases in PET film, which can result from the production process or winding thereof, it has been shown in an exemplary embodiment to be advantageous if the PET film is preheated before application of the top layer material. Temperatures in the range of 40-80° C. have been found to be advantageous in this case. This temperature exposure is sufficient to allow possible creases during unwinding of the PET film, i.e. during provision of the carrier surface, to be smoothed out. This can be carried out for example by applying a tensile force in a uniaxial and/or biaxial direction.

In the following method step b), the surface material still to be cured can be adjusted to the desired layer thickness. Because of the layered structure of the plastic composite, it is possible, beginning with the top layer, to adjust and control the properties thereof in a particularly simple and targeted manner. Adjustment of the layer thickness of the top layer material still to be cured is carried out using a doctor blade. The layer thickness adjusted here corresponds to the top layer deep-cured in the following step.

It must be taken into account that the layer thickness adjusted here is selected such that the layer thickness in the deep-cured state in step c), taking into account volume shrinkage, is in the range of 40 to 150 μm, advantageously in the range of 90 to 110 μm. Advantageously, the top layer applied here shows volume shrinkage of only 0.5-4% based on the original volume.

In method step c), the top layer material is exposed to UV radiation. For this purpose, for example, a gallium-doped UV irradiation source is used. In order to achieve particularly effective and even deep curing, the UV radiation is emitted from above and strikes the exposed surface of the top layer. Consequently, the top layer is exposed to UV radiation from behind based on the subsequent layered structure of the plastic composite. Deep crosslinking is initiated. The deep-cured top layer is formed. This provides the additional advantage that the side of the top layer facing away from the radiation, which forms a continuous common contact surface with the carrier surface, remains smooth and even. The structure of this common contact surface is determined by the structure of the carrier surface. In the subsequent final plastic composite product, this common contact surface is the visible surface, which is also directly exposed to the effects of the weather and UV radiation.

In addition, the rear-side irradiation of the top layer allows the course of curing to be controlled. This is realized by combination with a deep-curing UV initiator, for example from the group of the phosphine oxides. In this way, for the first time in the thin layer production process, a controlled deep curing can be provided. The exposed surface of the top layer, which is directly irradiated with the UV radiation, is only converted to 80-50%. As the layer thickness progresses in the direction of the carrier surface, the conversion percentage increases. Advantageously, a crosslinking rate of greater than 90% can be achieved at the interface between the carrier surface and the top layer. In this way, the later visible surface is cured and thus stabilized. Subsequent folds in the production process can therefore be excluded. However, the exposed surface remains only partially cured. This is advantageous in that the top layer remains chemically reactive on the exposed surface.

It is optionally possible that before and/or in and/or after the area of UV irradiation, the temperature of the carrier material with the top layer applied is controlled. For this purpose, temperature-controllable plate elements for guiding the carrier material can be arranged underneath it. The plate elements can be understood as supporting surfaces over which a carrier material with a top layer is guided. These can dissipate, in a rapid and controlled manner, a possible temperature input which can result during UV irradiation. This prevents melting of the carrier material.

Furthermore, it is optionally conceivable that a carrier material with a liquid top layer is already preheated prior to UV irradiation. This can have a positive effect on the flatness of the carrier film, so that the formation of wrinkles on the top layer arranged thereon during the subsequent curing is prevented.

This proves to be particularly advantageous when the matrix layer material is applied in the following step d). Because of the still chemically reactive outer surface of the top layer, to which the matrix material is at least partially, advantageously completely applied, it can chemically interact therewith. Thus it is for example conceivable that the top layer and the matrix layer covalently or non-covalently interact with each other. In this way, the adhesion properties of the two layers to each other can be significantly improved. It is also conceivable that the two layers are subsequently covalently bonded to each other via a radical polymerization reaction.

In the following method step d), the matrix material is applied to form the matrix layer. The matrix material is applied to the top layer. For example, layer adjustment can be carried out analogously to the surface layer. Thus it is conceivable in an exemplary embodiment that the layer thickness of the matrix layer can be predetermined using a doctor blade.

Following this, in the following method step e), the reinforcing material is introduced into the matrix layer. Woven or nonwoven textiles, laid nets, mats, short fibers or other fibers can be introduced as fiber reinforcement materials. For this purpose, various types of fibers can be used, such as e.g. glass fibers, carbon fibers, basalt fibers and/or polymer fibers, such as e.g. aramid fibers, and combinations thereof.

In a particularly advantageous embodiment, glass fibers have been found to be particularly advantageous, as in addition to chopped fibers, they can also be used as semifinished textile products, advantageously as preassembled chopped glass mats. These chopped glass mats prove to be particularly advantageous in that they have a fixed distribution of glass fibers within 1 square meter. The fibers are fixed with a binder, which prevents the fibers from shifting during impregnation. In the case of cut glass, shifting cannot be prevented. Furthermore, the distribution of the glass, due the available cutting technology, is significantly less precise, which results in poorer evenness of the surface and provides less consistent and reliable reinforcement. For this reason, semifinished textile products, advantageously chopped glass mats, are advantageously used in the plastic composite described here. In addition, the chopped glass mats have been found to be advantageous in that they can be introduced over the entire matrix layer in planar fashion and are therefore uniformly distributed. Precisely in the case of statistical chopped fiber distribution, this is difficult because uneven accumulations of chopped fibers occur. This then has a detrimental effect on the quality of the matrix layer. This often leads to high product reject rates.

Advantageously, the glass fibers used are E-glass, which is used for electrical applications or plastic reinforcements. E-glass can advantageously be understood to be aluminum borosilicate glass, which is substantially free of alkali metal oxides. Of course, this is not to be construed as restrictive, so any other types of glass can also be used here as a reinforcing material.

For this reason, in a particularly advantageous embodiment of the method described here, chopped glass mats are used for fiber reinforcement of the plastic composite. These chopped glass mats are introduced in the matrix layer, which is not yet cured. Because of the capillary forces and the flat configuration of the chopped glass mats, advantageously over the entire production width of the matrix layer, the chopped glass mats sink slowly and in a controlled manner into the matrix layer. The chopped glass mat dips in, so to speak, and is saturated with the matrix material. This causes the chopped glass mat to be impregnated at the same time.

This controlled feeding of the chopped glass mats into the matrix layer that is still to be cured and the coarse configuration thereof allow air inclusions to be completely prevented. Due to the capillary forces and the coarse structure of the chopped glass mats, possible air inclusions are transported upwards and escape from the matrix layer. Consequently, this results in a high-quality matrix layer, which is cured in the following step f).

Of course, as the use of cut glass fibers and/or chopped glass mats is not to be construed as restrictive, instead of the chopped glass mats, for example, carbon fiber mats or polymer fiber mats can be used.

Advantageously, the curing in method step f) is carried out thermally. Depending on the choice of matrix material, and in particular on whether it also comprises unsaturated groups, the top layer and matrix layer can covalently or non-covalently interact with each other in order in this manner to form an interconnected layered structure as a composite.

If the matrix material is selected from the group of an unsaturated polyester resin, vinyl ester resin, epoxy resin and/or polyurethane resin and/or at least one combination thereof, the layered composite is thermally cured. Of course, this is not to be construed as restrictive, so there are also further curing possibilities. Depending on the subsequent use, the matrix layer, in which the reinforcing material is already arranged, can have a layer thickness in the cured state in the range of 0.3-5 mm.

In the last step g), the carrier surface is removed. If it is configured for example as a film, the film can simply be pulled downward from the plastic composite and, for example, be rolled up again.

The end product then be assembled. It is advantageously configured as a plate.

If the plastic composite is intended for special applications, it is conceivable that, for example, the side with the outer matrix layer is further treated. This can for example involve increasing the adhesion properties, or also corona treatment and/or flame treatment in order to adjust the wettability and polarity of the surface. The top layer, on the other hand, remains as produced. Finally, the side surfaces of the plastic composite can optionally be polished. In this way, a wider range of installation options can be provided in use as façade components.

In a further advantageous embodiment, it has been found to be advantageous to configure the method described herein as a continuous method. In this way, plastic composites up to 4 m wide which can have a length of up to 250 m can be produced in a short production period.

In a further advantageous embodiment, it has been found to be advantageous to add a further step at least between step c) and d) in which at least one separating layer is applied to the deep-cured top layer. The separating layer serves in particular to reduce the fiber imprint that can later be formed by fiber reinforcement of the matrix layer. The separating layer can advantageously be introduced as a glass fleece and prevents an above-average impression of the glass fibers at the interface between the top layer and matrix layer.

In a further advantageous embodiment, it has been found that, at least between steps e) and f), a further carrier material is advantageously applied in order to cover the matrix layer. In the simplest case, this carrier material can be configured as a film, even more advantageously as a PET film. Thus it is conceivable that the carrier material for covering the matrix layer is the same as the carrier material for applying the top layer. This additional covering serves to improve curing and reduce defects during the entire production process.

In a further advantageous embodiment, an additional method step can be carried out between steps f) and g). This step can be carried out as a step of UV post-curing of the top layer from the exposed rear side of the carrier material. In the additional method step, the top layer is post-cured. As already mentioned above, at this point, the top layer has only been deep-cured. By means of the subsequent post-curing, which is carried out by UV irradiation, the top layer can now be completely cured. In particular, the common contact surface between the top layer and the matrix layer is still reactive and not completely cured and crosslinked. In addition, the advantage of this post-curing lies in that it allows a significant reduction in crack resistance to be achieved.

For this reason, it has been found to be advantageous to carry out a post-curing step. Here, it has been found to be particularly advantageous and effective if the UV irradiation is carried out from below. This means that the UV irradiation source is arranged underneath the layered structures described here. In this way, the UV irradiation is directly introduced through the carrier surface onto the top layer. This has proven to be particularly advantageous, as it is not necessary to expose the entire matrix layer material with the embedded fiber reinforcement to UV irradiation. This UV irradiation from below can produce an advantageously complete deep crosslinking and hardening of the upper layer at the interface to the matrix layer in a particularly short time. After only 3 to 15 seconds, the top layer is cured at the above-mentioned layer thicknesses. In this way, the production process is designed to save time and money.

The method described herein can also be understood as a method in which a plastic composite is produced as described above.

Furthermore, the present invention relates to use of a plastic composite according to the present invention as a surface component for interior paneling and/or exterior paneling of vehicles, aircraft, trains, ships, campers, RVs, as a surface element for logistics and transport, for example for truck bodies, and/or as a façade element in the construction industry. In this way, preservation of value is achieved, as there is virtually no impairment of visual appearance due to yellowing of the plastic composite.

Furthermore, the invention also relates to a plastic composite which is produced according to the above-mentioned production process.

For the first time, the plastic composite described herein can be produced over large square meter areas. Thus, for example, it is possible for the plastic composite to have an area of at least 1 m×at least 1 m, at least 1 m×1.5 m, at least 1.5 m×1.5 m, at least 1 m×at least 2 m, at least 2 m×at least 2 m, or at least 2 m×at least 4 m. Advantageously, the plastic composite has a flat shape. Depending on use, the plastic composite can be configured as sheets or rolls. Consequently, large areas can be covered with the plastic composite described herein without having to divide it into sections. This gives rise to a particularly esthetic appearance during use.

Furthermore, it has been found that the urethane acrylate resin-based top layer does not initially cause the plastic composite to have a higher surface hardness per se. However, because of the low layer thickness of the top layer, the high hardness of the matrix material has a greater impact. At the same time, this improves its quality. For example, if a dirt particle is pressed into the top layer, it is more difficult to displace it because of the low layer thickness. This means that the indentation is significantly weaker. This is particularly advantageous because the plastic composite described herein is often subjected subsequently to further processing using pressing methods. The result is that cases of dirt particles between the press surface and the plastic composite are more frequent. Consequently, the low layer thickness can significantly reduce indentations due to pressure applied due to dirt. A pressure of 1.5-4 t/m² is often used. As a result, there is a significantly lower rate of rejects due to pressed-in dirt.

The invention described herein advantageously shows high UV resistance while retaining the gloss level, with virtually no change in color. This can be achieved in particular by means of the coloring additives in the top layer.

Furthermore, the coloring additives, advantageously color pigments, have been found to be advantageous because they protect the underlying matrix layer, which is not UV-stabilized and for example is composed of an unsaturated polyester and/or epoxy resin, from UV irradiation and thus prevent yellowing.

Furthermore, it has been found that the mechanical properties of the plastic composite described herein can be adjusted by a factor in the range of 15-20 by using different fiber reinforcements. The result is a range of properties according to DIN EN ISO 527-4/2/2:
Short fiber mats: strength approx. 60 N/mm² | elastic modulus approx. 6000 N/mm²
Fabric reinforcement: strength approx. 150 N/mm² | elastic modulus approx. 10000 N/mm²
Scrim reinforcement biaxial: strength approx. 400 N/mm² | elastic modulus approx. 23000 N/mm²
Scrim reinforcement uniaxial: strength approx. 1000 N/mm² | elastic modulus approx. 45000 N/mm²
Scrim reinforcement uniaxial carbon fibers: strength approx. 1300 N/mm² | elastic modulus approx. 110000 N/mm².

Further advantages, features, and configuration possibilities can be found in the exemplary embodiments, which are to be understood as non-restrictive. In all cases herein where the term “substantially” is used within the scope of the present invention, the term is to be understood as referring to a variation in the range of 1% to 20%, more advantageously 1% to 10%, even more advantageously 1% to 5%, of the definition that would have been given without using this term.

### DETAILED DESCRIPTION OF EXEMPLARY EMBODIMENTS

The abbreviation “phr” is to be understood as parts by weight per 100 parts of the respective base layer material of the top layer or matrix layer in the liquid state.

### 1. External Camper Side Wall

In the exemplary embodiment of an external camper wall described here, the produced end product has a total thickness of 1.5 mm±0.1 mm and a total width of 2.8 m. As the production process is configured as a continuous process, the product length is variable and can be tailored to customer requirements.

First, a liquid surface material is applied to a biaxially stretched film, advantageously a PET film. Immediately after this, layer thickness is adjusted using a doctor blade to 110 μm±15 μm. The PET film serves as a carrier material and can itself have a thickness of 10-400 μm, wherein a thickness of the PET film of 100 μm has been found to be particularly advantageous. It is sufficiently stable to serve as a carrier film and still sufficiently thin so that the UV radiation necessary for UV crosslinking can pass through.

Advantageously, the surface material can be configured to comprise at least one urethane acrylate.

The applied surface material in this exemplary embodiment can comprise the following compositions:
100 phr urethane acrylate (Laromer UA9089)
0.5 phr Hostavin 3058 LIQ
0.5 phr Tinuvin 1130 as a UV absorber
4 phr titanium dioxide
1.5 phr TPO-L as a deep-curing UV initiator
or
100 phr urethane acrylate (Ebercryl IRR 1032)
0.5 phr Hostavin 3058 LIQ
0.5 phr Tinuvin 1130 as a UV absorber
4 phr titanium dioxide
1.5 phr TPO-L as a deep-curing UV initiator

After adjustment of the layer thickness, the liquid surface material applied to the carrier material is exposed from above to at least one UV irradiation source. UV irradiation thus takes place directly via the exposed surface of the surface material layer. Advantageously, a gallium-doped mercury lamp is used for this purpose as a UV irradiation source. This advantageously emits a UV dose of 400 mJ/cm²±10%. Advantageously, the duration of irradiation is in the range of 3-30 seconds, more advantageously 5 to 15 seconds, and even more advantageously 5 seconds, 6 seconds, 7 seconds, 8 seconds, 9 seconds, 10 seconds, 11 seconds, 12 seconds, 13 seconds, 14 seconds, or 15 seconds.

The PET film configured as a carrier material also serves the purpose of preventing oxygen inhibition at the film-surface material interface. In this way, a high crosslinking rate of >90% is achieved in the area of this interface. On the other hand, the exposed surface is in contact with the air and is inhibited by oxygen. This results in a degree of crosslinking of 50 to 80% of the exposed surface.

In the deeper layers, which are not affected by oxygen inhibition of the curing agent radicals, a degree of crosslinking of >90% is ordinarily achieved (measured by IR-ATR; calculated via the peak area of the C═C double bond). In this respect, it should be stated that IR-ATR radiates light onto a sample in a wave number range of 400-4000 (cm⁻¹). The radiation is absorbed at the surface by the covalent bonds present before the remainder is reflected back to the device. The double bond decrease is relevant for measurement of crosslinking. The double bond produces its own specific peak at approx. 809 cm⁻¹. Lambert-Beer's law applies here, which means that the peak area is directly proportional to the concentration of the bond.

For this reason, the liquid sample is first measured, with the area under the measured peak being integrated. This area corresponds to a degree of crosslinking of 0% or 100% non-crosslinked bonds. After curing, integration is carried out again, and the area again indicates how many bonds have not yet been crosslinked. The difference between the two corresponds to the degree of crosslinking achieved. In a subsequent step, the matrix material is applied to the at least partially UV-cured exposed surface of the surface material. The layer thickness of the matrix material can be adapted to later use. In the present exemplary embodiment, a layer thickness of 1100 μm±100 μm is selected. The layer thickness is adjusted using another doctor blade.

In the example described here, the matrix material has the following composition:

100 phr unsaturated resin, advantageously the moderately reactive, orthophthalic acid-based matrix resin Palatal P4 L21
5 phr titanium dioxide
0.15 phr cobalt accelerator 1%
1.7 phr curing agent, advantageously Curox 1300

Examples of cobalt accelerators that can be used include solvents such as styrene, xylene, TXIB, and 2-ethylhexan-1-ol with a corresponding cobalt content.

In the present exemplary embodiment, reinforcing materials are introduced into the matrix material that has been drawn off. Due to the still-liquid aggregate state of the matrix material, the reinforcing materials can sink into the matrix material layer and are substantially completely, advantageously completely, enclosed by it. This causes the reinforcing material to be simultaneously impregnated. For the application mentioned in this exemplary embodiment, chopped glass mats are usually selected as the reinforcing material. The chopped glass mat has a basis weight of 375 gr/m². Alternatively to the chopped glass mats, cut glass fibers can also be used for reinforcement.

Advantageously, in order to reduce the fiber print of the cut glass fibers and/or chopped glass mats, at least one separating layer is arranged before or after application of the matrix layer between the top layer and the cut glass fibers and/or the chopped glass mat. Advantageously, the separating layer is configured as a glass fleece. The glass fleece used here also advantageously has a basis weight of 20 g/m². This provides improved stability and prevents the individual cut glass fibers and/or the glass fibers of the mats from being pressed into the top layer, and in the worst case, protruding through the layer from the plastic composite. In addition, this makes the interface between the top layer and the fibers more even, and the fiber structure is optically covered and minimized.

In the exemplary embodiment described here, the structure of the individual layers is as follows:
top layer
separating layer, advantageously a glass fleece
matrix layer with embedded chopped strand mat
or
top layer
matrix layer with embedded separating layer, advantageously configured as a glass fleece and embedded chopped glass mat

Finally, another carrier film, advantageously a PET film, is applied to the matrix layer. This prevents oxygen inhibition during the curing of the matrix material. In order to remove air inclusions between the PET film and the resin, the entire layer system is calendered. After this, the matrix material is temperature-cured by heating it to 100° C. for 20 minutes. The plastic composite produced is then cooled back down to room temperature. In order to crosslink the top layer containing urethane acrylate, the plastic composite is again exposed to UV radiation. This can be carried out with an additional, advantageously deep-curing UV irradiation source, for example composed of a gallium or iron-doped mercury lamp that emits a dose of 400 mJ/cm²±10%. This irradiation source is arranged below the layer system in the production process and thus acts first on the carrier surface and then the top layer. Irradiation is therefore carried out from below. The duration of irradiation is advantageously in the range of 3-30 seconds, more advantageously 5 to 15 seconds, and even more advantageously of 5 seconds, 6 seconds, 7 seconds, 8 seconds, 9 seconds, 10 seconds, 11 seconds, 12 seconds, 13 seconds, 14 seconds, or 15 seconds.

In the penultimate step, the two carrier films, which until now have limited the area of the plastic composite, are then removed. The plastic composite is then assembled. It has been shown that a plastic composite produced in this manner has a tensile strength according to DIN EN ISO 527-4/2/2 of 70 N/mm² and a tensile elastic modulus according to DIN EN ISO 527-4/2/2 of 6000 N/mm².

In this exemplary embodiment described here, the plastic composite produced has a glass content of 20-30 wt % based on the total mass of the cured plastic composite.

The plastic composite described herein with the two possible top layer alternatives shows significantly increased gloss retention, virtually no yellowing in the test method according to DIN-EN-ISO 4892-2-A1, and a reduction in weight of about 100 g/m² compared to known fiber-reinforced plastic panels, while having improved mechanical properties. In particular, the significant reduction in yellowing and retention of gloss levels over decades, determined by the Xeno-test, a test method according to DIN EN ISO 4892-2-A1 (see above), also known as the Accelerated Weathering Test according to DIN EN ISO 4892-2-A1, are highly relevant for maintaining value in the camping sector. For example, if a camper looks almost new even after 15 years, shiny white with no dull yellowing, this provides a significantly higher resale value.

### 2. Commercial Vehicle External Side Wall

In the second exemplary embodiment described herein, the manufactured end product, i.e. the plastic composite, is used for a commercial vehicle external side wall. The plastic composite produced according to the second exemplary embodiment has a total thickness of 1.4 mm+0.1 mm and a total width of 2.4 m. As the production process is configured as a continuous process, the product length is variable and can be tailored to customer requirements.

First, a liquid surface material is applied to a biaxially stretched film, advantageously a PET film. Immediately after this, the layer thickness is adjusted using a doctor blade to 110 μm±15 μm. The PET film serves as a carrier material and can itself have a thickness of 10-400 μm, wherein a thickness of the PET film of 100 μm has been found to be particularly advantageous. It is sufficiently stable to serve as a carrier film and still sufficiently thin so that the UV radiation necessary for UV crosslinking can pass through.

Advantageously, the surface material can be configured to comprise at least one urethane acrylate.

The applied surface material in this exemplary embodiment can comprise the following compositions:
100 phr urethane acrylate (Laromer UA9089)
0.5 phr Hostavin 3058 LIQ
0.5 phr Tinuvin 1130 (UV absorber)
4 phr titanium dioxide (for tinted whites or colors, more
pigment types may be added)
1.5 phr TPO-L
or
100 phr urethane acrylate (Ebercryl IRR 1032)
0.5 phr Hostavin 3058 LIQ
0.5 phr Tinuvin 1130 (UV absorber)
4 phr titanium dioxide (for tinted whites or colors, more pigment types may be added)
1.5 phr TPO-L

The liquid surface material applied to the carrier material, after adjustment of the layer thickness, is exposed to at least one UV irradiation source from above. The UV irradiation thus takes place directly via the exposed surface of the surface material layer. Advantageously, a gallium-doped mercury lamp is used as an UV irradiation source for this purpose. It advantageously emits an UV dose of 400 mJ/cm²±10%. The irradiation takes place advantageously for 3-30 seconds, more advantageously for 5 to 15 seconds, and even more advantageously for 5 seconds, 6 seconds, 7 seconds, 8 seconds, 9 seconds, 10 seconds, 11 seconds, 12 seconds, 13 seconds, 14 seconds, or 15 seconds.

The PET film configured as a carrier material also serves the purpose of preventing oxygen inhibition at the film-surface material interface. In this way, a higher crosslinking rate of >90% is achieved in the area of this interface. The exposed surface, in contrast, is in contact with the air and is oxygen-inhibited. This results in a degree of crosslinking of 50 to 80% of the exposed surface. In deeper layers, which are not subject to oxygen inhibition of the curing agent radicals, a degree of crosslinking of >90% is ordinarily achieved (measured with IR-ATR; calculated via the peak area of the C═C-double bond—for measurement and evaluation, see exemplary embodiment 1—External Camper Wall).

In a subsequent step, the matrix material is applied to the exposed surface of the applied and at least partially cured top layer material. The layer thickness of the matrix material can be adapted to the subsequent use. In the exemplary embodiment disclosed herein, the matrix layer advantageously has a layer thickness in the range of 700 μm±50 μm.

Advantageously, the matrix layer is configured to comprise at least one epoxy resin and has the following composition:
100 phr Biresin LXR 121
26 phr Biresin LXH 121-3

The applied epoxy resin is applied to the rear side of the top layer, which here is configured to be partially cured, and then drawn off with a doctor blade with a layer thickness of 700 μm±50 μm.

In the present exemplary embodiment, reinforcing materials are introduced into the drawn-off matrix material. Due to the still-liquid aggregate state of the matrix material, the reinforcing materials can sink into the matrix material layer and are then substantially completely, advantageously completely, enclosed by it. This causes the reinforcing material to be simultaneously impregnated.

In the exemplary embodiment described here, the individual layers have the following structure:
top layer
matrix layer with
   a first biaxial glass fabric with a basis weight of 812 gr/m²
   a second biaxial glass fabric with a basis weight of 812 gr/m²

The biaxial glass fabrics used are semifinished textile products that have biaxially arranged glass roving strands.

The advantage of this biaxial glass fabric is that a higher glass content in the resulting plastic composite can be provided with consistent thickness. In this way, even more highly improved mechanical properties can be achieved with a low weight. Use of this biaxial glass fabric also results in a lower thermal expansion coefficient.

Finally, another carrier film, advantageously a PET film, is advantageously applied to the matrix layer. It must be suitable in that it can be demolded from the matrix layer, i.e. the epoxy resin, which constitutes the matrix layer in this exemplary embodiment. In order to remove air inclusions between the PET film and the resin, the entire layer system is calendered. After this, for temperature curing of the matrix material, it is heated to 100° C. for 30 minutes. The plastic composite is then cooled back down to room temperature. In order to crosslink the urethane acrylate containing top layer, the plastic composite is again exposed to UV radiation. This can be carried out with a further, advantageously deep-curing, UV irradiation source, for example configured as a gallium or iron-doped mercury lamp that emits a dose of 400 mJ/cm²±10%. In the production process, this irradiation source arranged below the layer system directly irradiates the top layer. Irradiation is thus carried out from below. Irradiation is carried out advantageously for 3-30 seconds, more advantageously for 5 to 15 seconds, and even more advantageously for 5 seconds, 6 seconds, 7 seconds, 8 seconds, 9 seconds, 10 seconds, 11 seconds, 12 seconds, 13 seconds, 14 seconds, or 15 seconds.

In the penultimate step, the two carrier films, which until now have limited the area of the plastic composite, are removed. The plastic composite is then assembled. It has been shown that a plastic composite produced in this manner has a tensile strength according to DIN EN ISO 527-4/2/2 of 400 N/mm² and a tensile elastic modulus according to DIN EN ISO 527-4/2/2 of 23000 N/mm². The plastic composite described herein shows significantly increased gloss retention, virtually no yellowing, and a reduction in weight of up to 100 g/m² compared to known fiber-reinforced plastic panels, while having improved mechanical properties. In particular, the significant reduction in yellowing and retention of gloss levels over decades, determined via a test method (also referred to as the Xeno-test method) according to DIN EN ISO 4892-2-A1, also referred to as the Accelerated Weathering Test Method according to DIN EN ISO 4892-2-A1, is highly relevant for value retention in truck bodies. For example, if the truck structure still looks almost new after 15 years, shiny white with no dull yellowing, this provides a significantly higher resale value. In addition, it shows high erosion resistance.

### 3. Curtain Wall Panel for the Construction Industry

In the third exemplary embodiment described here, the plastic composite produced according to this exemplary embodiment is used as a curtain wall panel, for example in the construction industry. The produced plastic composite, i.e. the end product, has a total thickness of 5.0 mm+0.15 mm and a total width of approx. 2.4 m. As the production process is also configured as a continuous process, the product length is variable and can be tailored to customer requirements.

First, a liquid surface material is applied to a biaxially stretched film, advantageously a PET film. Immediately after this, the layer thickness is adjusted using a doctor blade to 110 μm±0.15 μm. The PET film serves as a carrier material and can itself have a thickness of 10-400 μm, wherein a thickness of the PET film of 100 μm has been found to be particularly advantageous. It is sufficiently stable to serve as a carrier film and still sufficiently thin so that the UV radiation necessary for UV crosslinking can pass through. Advantageously, the surface material can be configured to comprise at least one urethane acrylate.

The applied surface material in this exemplary embodiment can comprise the following compositions:
100 phr urethane acrylate (Laromer UA9089)
0.5 phr Hostavin 3058 LIQ
0.5 phr Tinuvin 1130 (UV absorber)
4 phr titanium dioxide (for tinted whites or colors, further
pigment types can be added)
1.5 phr TPO-L
or
100 phr urethane acrylate (Ebercryl IRR 1032)
0.5 phr Hostavin 3058 LIQ
0.5 phr Tinuvin 1130 (UV absorber)
4 phr titanium dioxide (for tinted whites or colors, further
pigment types can be added)
1.5 phr TPO-L

After adjustment of the layer thickness, the liquid surface material applied to the carrier material is irradiated from above by at least one UV irradiation source. UV irradiation thus takes place directly via the exposed surface of the surface material layer. Advantageously, a gallium-doped mercury lamp is used as a UV irradiation source. This advantageously emits a UV dose of 400 mJ/cm²±10%. Advantageously, irradiation is carried out for 3-30 seconds, more advantageously 5 to 15 seconds, and even more advantageously 5 seconds, 6 seconds, 7 seconds, 8 seconds, 9 seconds, 10 seconds, 11 seconds, 12 seconds, 13 seconds, 14 seconds, or 15 seconds.

The PET film configured as a carrier material also serves the purpose of preventing oxygen inhibition at the film-surface material interface. In this way, a high crosslinking rate of >90% is achieved in the area of this interface. On the other hand, the exposed surface is in contact with the air and is inhibited by oxygen. This leads to a degree of crosslinking of 50 to 80% of the exposed surface. In deeper layers, which are not affected by oxygen inhibition of the curing agent radicals, a degree of crosslinking of >90% is ordinarily achieved (measured by IR-ATR; calculated via the peak area of the C═C double bond; for measurement and evaluation, see exemplary embodiment 1—External Camper Wall). In a subsequent step, the matrix material is applied to the at least partially UV-cured exposed surface of the surface material. The layer thickness of the matrix material can be adapted to the subsequent use. In the present exemplary embodiment, a layer thickness of the liquid matrix material of 3700±100 μm is selected. The adjustment of the layer thickness is carried out using another doctor blade.

In the example described here, the matrix material has the following composition:

100 phr unsaturated resin, advantageously the moderately reactive orthophalic acid-based matrix resin Palatal P4 L21
5 phr titanium dioxide (for tinted whites or colors, further pigment types can be added)
0.15 phr cobalt accelerator 1%
1.7 phr curing agent (e.g. Curox 1300)

In the present exemplary embodiment, reinforcing materials are introduced into the matrix material that has been drawn off. The introduction of the reinforcing materials is carried out from above. Due to the still-liquid aggregate state of the matrix material, the reinforcing materials sink into the matrix material layer and are substantially completely, advantageously completely enclosed by it. The reinforcing material is thus simultaneously impregnated. For application mentioned in this exemplary embodiment, chopped glass mats are ordinarily selected as a reinforcing material. Alternatively to chopped glass mats, chopped fibers can also be introduced for reinforcement.

To reduce the fiber print of the cut glass fibers and/or chopped glass mats, at least one separating layer is advantageously arranged before or after the application of the matrix layer between the top layer and the chopped glass fibers and/or the chopped glass mat. Advantageously, the separating layer is configured as a glass fleece. Furthermore, the glass fleece used here advantageously has a basis weight of 20 g/m². This provides improved stability and prevents the individual cut glass fibers and/or the glass fibers of the mats from pressing into the top layer, and in the worst case, protruding through the layer from the plastic composite. In addition, this makes the interface between the top layer and fibers more even, and the fiber structure is optically covered.

In the exemplary embodiment described here, the structure of the individual layers is as follows:
top layer
glass fleece with a basis weight of 20 g/m²
matrix layer with
first chopped glass mat with a basis weight of 375 gr/m²
second chopped glass mat with a basis weight of 375 gr/m²
third chopped glass mat with a basis weight of 375 gr/m²
fourth chopped glass mat with a basis weight of 375 gr/m²
continuous mat with a basis weight of 450 gr/m²
or
top layer
matrix layer with
   embedded separating layer, advantageously configured as a glass fleece with a basis weight of 20 g/m²
   first chopped glass mat with a basis weight of 375 gr/m²
   second chopped glass mat with a basis weight of 375 gr/m²
   third chopped glass mat with a basis weight of 375 gr/m²
   fourth chopped glass mat with a basis weight of 375 gr/m²
   continuous mat with a basis weight of 450 gr/m²

The four chopped glass mats used here are successively introduced into the matrix layer, which is still to be cured. Due to capillary action, one chopped glass mat after the other is saturated and enclosed by the matrix layer. Advantageously, glass fleece and continuous mats, advantageously also from above, are introduced into the matrix layer, which is still to be cured. It has been found to be advantageous to introduce four individual chopped glass mats one after the other into the matrix layer. This results in a highly uniform distribution of the matrix material. For example, if only one thick chopped glass mat, which would correspond to the four individual mats, were introduced, matrix layer material would be pressed out laterally, and the entire plastic composite would be defective.

Finally, another carrier film, advantageously a PET film, is advantageously applied to the matrix layer. This prevents oxygen inhibition during curing of the matrix material. In order to remove air inclusions between the PET film and the resin, the entire layer system is calendered. After this, for temperature curing of the matrix material, it is heated to 90° C. for 30 minutes. The plastic composite is then cooled back down to room temperature. In order to crosslink the urethane acrylate containing top layer, the plastic composite is again exposed to UV radiation. This can be carried out with a further, advantageously deep-curing, UV irradiation source, for example configured as a gallium or iron-doped mercury lamp that emits a dose of 400 mJ/cm²±10%. In the production process, this irradiation source arranged below the layer system directly irradiates the top layer. Irradiation is thus carried out from below. Irradiation is carried out advantageously for 3-30 seconds, more advantageously for 5 to 15 seconds, and even more advantageously for 5 seconds, 6 seconds, 7 seconds, 8 seconds, 9 seconds, 10 seconds, 11 seconds, 12 seconds, 13 seconds, 14 seconds, or 15 seconds.

In the penultimate step, the two carrier films, which until now have limited the area of the plastic composite, are then removed. The plastic composite is then assembled. It has been shown that a plastic composite produced in this manner has a tensile strength according to DIN EN ISO 527-4/2/2 of 60 N/mm² and a tensile elastic modulus according to DIN EN ISO 527-4/2/2 of 6000 N/mm².

The plastic composite described herein with the two possible top layer alternatives shows significantly increased gloss retention, virtually no yellowing, and a reduction in weight of up to 100 g/m² compared to known fiber-reinforced plastic panels, while having improved mechanical properties. In particular, the significant reduction in yellowing and retention of gloss levels over decades, as determined via the Xeno-test method according to DIN EN ISO 4892-2-A1, also known as the Accelerated Weathering Test according to DIN EN ISO 4892-2-A1, are highly relevant for maintaining the value of the façade elements. The plastic composite described herein is particularly advantageous in the construction sector, in which building façades are intended to appear attractive for decades. For example, façade elements can be provided that look almost new even after decades of outdoor weathering. It has high erosion resistance. There is no need for expensive renovation measures or exchanging façade elements. This allows significant cost savings to be achieved.

Advantageously, the term Xeno-test is understood to refer to a test method which is carried out according to DIN EN ISO 4892-2-A1. This test method according to DIN EN ISO 4892-2-A1 may also be referred to as the Accelerated Weathering Test according to DIN EN ISO 4892-2-A1 or the Accelerated Weathering Test Method according to DIN EN ISO 4892-2-A1.

Further advantages, features, and configuration possibilities are given in the following description of the figures concerning exemplary embodiments which are to be understood as non-restrictive.

### BRIEF DESCRIPTION OF THE DRAWING

FIG. 1 Diagram of the test method according to DIN EN ISO 4892-2-A1;

FIG. 2 further diagram of the test method according to DIN EN ISO 4892-2-A1;

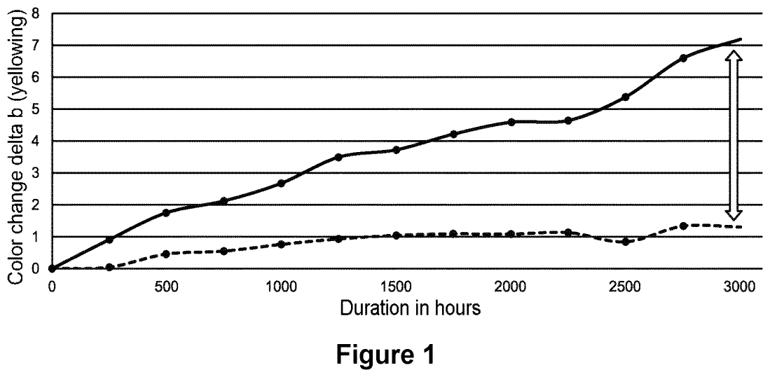

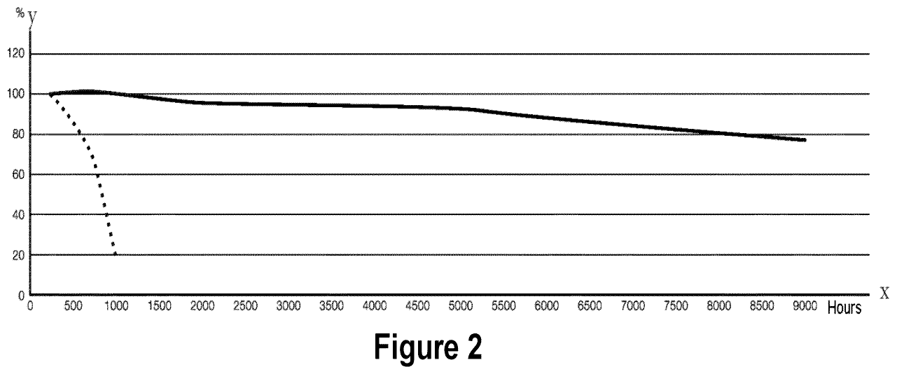

The data on the accelerated weathering of the test method according to DIN EN ISO 4892-2-A1 determined as described above using the spectrophotometer are shown in FIG. 1 and FIG. 2.

FIG. 1 shows the behavior of the plastic composite described herein (dashed line) under artificial weathering according to the Accelerated Weathering Test Method according to DIN EN ISO 4892-2-A1 as color change Delta b (yellowing) (y axis) over time (x axis). The plastic composite described, which advantageously comprises in the top layer at least 1.5 wt % pigment and max. 8 wt % pigment based on the total mass of the top layer in the cured state, for example titanium dioxide, with said top layer advantageously being composed of urethane acrylate, is shown as a dashed line. It can be seen that the yellowing over time increases only very slowly to a value of 1.5. This means that at most, there is a very slight color difference, which, however, is not perceived by the viewer himself. In comparison, the solid line shows the same plastic composite, but without color pigment in the top layer. It can be seen that yellowing of the matrix layer sets in particularly quickly.

FIG. 2 shows loss of gloss (y axis) over time (x axis) under artificial weathering according to the DIN EN ISO 4892-2-A1 test method. The plastic composite described herein, which advantageously comprises in the top layer at least 1.5 wt % pigment and max. 8 wt % pigment based on the total mass of the top layer in the cured state, for example titanium dioxide, with the top layer advantageously being composed of urethane acrylate, is shown as a solid line. It can be seen that the loss of gloss decreases only slightly over years. After about 9000 hours of testing according to DIN EN ISO 4892-2-A1, the gloss level remains at about 80% of the original new gloss level of 100%. The gloss level is determined by measuring the ratio of incident light to light reflected from the surface, taking into account the angle of specular reflection, using a reflectometer. Here, a BYK-Gardner “tri-gloss” reflectometer with a measuring angle of 20° was used as a measuring device. In comparison, the dotted line shows the same plastic composite with a top layer according to the previous standard (isophthalic acid-based polyester resin with neopentyl glycol). It can be seen that in the test method according to DIN EN ISO 4892-2-A1, the loss of gloss is more than 80% after only a very short time, about 1000 hours.

Although the invention has been more closely illustrated and described in detail by means of the advantageous exemplary embodiments, the invention is not restricted by the examples disclosed. Other variations thereof can be derived therefrom by the person skilled in the art without departing from the scope of protection of the invention. In particular, the invention is not limited to the combinations of features given below, but other combinations and partial combinations that are obviously executable for the person skilled in the art can also be formed based on the disclosed features.

1-16. (canceled)

17. A fiber-reinforced, multilayer, flat plastic composite with improved UV resistance, comprising at least
a. a matrix layer for forming a supporting matrix body and furthermore
b. at least one top layer arranged on the matrix layer, which is configured as a surface seal of the matrix layer and/or as a UV protection layer of the matrix layer, wherein the matrix layer comprises at least one resin selected from the group consisting of an unsaturated polyester resin, a vinyl ester resin, an epoxy resin, a polyurethane resin, and a combination thereof, and the top layer comprises at least one acrylate-based resin, wherein at least the matrix layer has a fiber-reinforced configuration, and
wherein the top layer has a layer thickness in the cured state in the range of 40 to 150 μm, wherein the plastic composite in a 1000-hour test method according to DIN-EN-ISO 4892-2-A1, in the color measurement space L/a/b, has a value delta E of <1.0 and in a 3000-hour test method according to DIN-EN-ISO 4892-2-A1, in the color measurement space L/a/b, has a value delta E of <1.7.

18. The fiber-reinforced, multilayer plastic composite as claimed in claim 17, wherein the top layer comprises at least one deep-curing UV initiator.

19. The fiber-reinforced, multilayer plastic composite as claimed in claim 18, wherein the at least one deep-curing UV initiator comprises a phosphine oxide group.

20. The fiber-reinforced, multilayer plastic composite as claimed in claim 17, wherein the matrix layer also comprises at least one type of fiber.

21. The fiber-reinforced, multilayer plastic composite as claimed in claim 17, wherein, at least one further separating layer is also arranged between the top layer and matrix layer.

22. The fiber-reinforced, multilayer plastic composite as claimed in claim 17, wherein the top layer and/or the matrix layer comprises at least one further additive.

23. The fiber-reinforced, multilayer plastic composite as claimed in claim 17, wherein there is a maximum 2 wt % loss of a reactive diluent based on the applied liquid layer material during the production process.

24. The fiber-reinforced, multilayer plastic composite as claimed in claim 17, wherein the top layer, after a 9000-hour test method according to DIN-30 EN-ISO 4892-2-A1, has a gloss retention of at least 70% of the original gloss level of 100%.

25. A method for producing a plastic composite as claimed in claim 17, having at least the following steps:
a. applying the top layer material to a carrier surface;
b. forming the top layer material into a layer on the carrier surface;
c. exposing the resulting top layer to UV radiation, so that the top layer undergoes deep curing;
d. applying the matrix material to form the matrix layer;
e. applying fiber material to the matrix layer, wherein the fiber material sinks into the still-liquid matrix layer and/or the fiber material is enclosed by the still-liquid matrix layer due to capillary forces;
f. curing of the matrix layer applied to the top layer; and
g. removing the carrier material to obtain the fiber-reinforced, multilayer plastic composite as the end product.

26. The method as claimed in claim 25, wherein the method comprises, at least between step c) and step d), a further step in which at least one separating layer is applied to the deep-cured top layer.

27. The method as claimed in claim 25, wherein at least between step e) and step f), a further carrier material is applied to cover the matrix layer.

28. The method as claimed in claim 25, wherein at least between step f) and g), UV post-curing of the top layer is carried out from the exposed rear side of the carrier material.

29. A fiber-reinforced, multilayer plastic composite produced by the method as claimed in claim 25.

30. A fiber-reinforced, multilayer, flat plastic composite with improved UV resistance, comprising at least
a. a matrix layer for forming a supporting matrix body and furthermore
b. at least one top layer arranged on the matrix layer, which is configured as a surface seal of the matrix layer and/or as a UV protection layer of the matrix layer, wherein the matrix layer comprises at least one resin selected from the group consisting of an unsaturated polyester resin, a vinyl ester resin, an epoxy resin, a polyurethane resin and a combination thereof and the top layer comprises at least one acrylate-based resin, at least produced by the method as claimed in claim 25.

31. A surface component for interior paneling and/or exterior paneling of a vehicle, aircraft, a train, a ship, a camper or RV, as a surface element for logistics and transport, or as a façade element in the construction industry comprising a fiber-reinforced, multilayer plastic composite as claimed in claim 17.

32. A surface component for interior paneling and/or exterior paneling of a vehicle, aircraft, a train, a ship, a camper or RV, as a surface element for logistics and transport, or as a façade element in the construction industry, produced by the method as claimed in claim 25.

33. The fiber-reinforced, multilayer plastic composite as claimed in claim 18, wherein the matrix layer also comprises at least one type of fiber.

34. The fiber-reinforced, multilayer plastic composite as claimed in claim 18, wherein, at least one further separating layer is also arranged between the top layer and matrix layer.

35. The fiber-reinforced, multilayer plastic composite as claimed in claim 18, wherein the top layer and/or the matrix layer comprises at least one further additive.
